(19) United States
(12) Patent Application Publication
(10) Pub. No.: US 2014/0057115 A1
(43) Pub. Date: Feb. 27, 2014

(54) COATING COMPOSITION AND METHOD

(71) Applicant: Gerald D. Treadway, Penngrove, CA (US)

(72) Inventor: Gerald D. Treadway, Penngrove, CA (US)

(73) Assignee: The Walman Optical Company, Minneapolis, MN (US)

(21) Appl. No.: 13/789,998

(22) Filed: Mar. 8, 2013

Related U.S. Application Data
(60) Provisional application No. 61/692,118, filed on Aug. 22, 2012.

(51) Int. Cl. C09D 183/04; C09D 171/00

(52) U.S. Cl. CPC C09D 183/04; C09D 171/00
USPC 428/412; 428/447; 427/387

(57) ABSTRACT

A substantially solvent-free coating composition for forming a transparent, abrasion-resistant, dye-accepting coating upon a substrate, the composition comprising a binder component and a curing agent component, the binder component comprising a partially hydrolyzed organo-functional silane and an oxetane selected from the group consisting of bi- or higher-functional aromatic oxetanes.

### FIELD OF THE INVENTION

The present invention relates to the field of transparent coatings for polymeric objects such as eyeglass lenses.

### BACKGROUND OF THE INVENTION

Transparent plastic materials such as eyeglass lenses are subject to becoming dull and hazy due to scratching and abrasion during use. Polycarbonate eyeglass lenses, for example, are strong and shatter resistant but also are relatively soft and susceptible to scratching. Television screen face plates similarly are made of flexible, shatter resistant plastic materials such as polycarbonate and poly(methylmethacrylate), and these also can be scratched or abraded.

Various coatings have been proposed for eyeglasses and other transparent plastic materials to reduce their propensity to become scratched and abraded. Besides being abrasion resistant, coatings for eyeglass lenses are often capable of being tinted by treatment with a dye which becomes incorporated in the coating. As a general observation, the tintability of a coating tends to decrease as its hardness and scratch resistance increases, and vice-versa. New lens materials are continually being developed, including those having high refractive indicies. The ability of conventional coating compositions to provide desired results with such new lens materials can be a concern.

Applicant has previously described improved coating compositions that can be used for providing various features. See, for example, U.S. Pat. Nos. 5,789,082; 5,907,000; 6,100,313; 6,250,760; 6,780,232; 7,037,585; 7,384,695; 7,514,482; and 7,981,514, the disclosures of which are incorporated herein by reference.

For instance, the above captioned U.S. Pat. No. 6,100,313 patent provides, inter alia, a coating composition that accepts dye well, that provides exceptional abrasion-resistance (AR), and that is substantially free of volatiles. The composition includes an at least partially hydrolyzed epoxy-functional alkoxysilane, and can also include a polymerizable ether selected from the group consisting of glycidyl ethers, allyl ethers and vinyl ethers, in combination with an ethylenically unsaturated monomer component, desirably an acrylic monomer component that preferably includes a monomer having an acrylic functionality of not more than two.

The above-captioned U.S. Pat. No. 7,514,482, in turn, provides a composition that includes colloidal silica, and which can include various ingredients, inter alia, a polymerizable monomer selected from the group consisting of one or more of the following, including combinations thereof: 1. ethylenically unsaturated monomers (e.g., vinyls, (meth)acrylates); 2. non-silane epoxies (e.g., epoxy ethers); 3. oxetanes; 4. alkylalkoxysilanes and/or tetraalkoxysilanes); 5. vinyl ethers; and 6. non-silane cycloaliphatic epoxies. The '482 patent, in turn, describes both a monofunctional cyclic oxetane compound (Cyracure UVR 6000) and an aliphatic oxetane compound (OXT 221).

There is an ongoing need and desire to provide coating compositions that are capable of providing lenses and other such surfaces with improved combinations of properties.

### SUMMARY OF THE INVENTION

The present invention provides a combination comprising a coated and cured composition as a layer upon the surface of a polymeric material, selected from the group consisting of:
a) a combination provided by curing on the polymeric surface a composition comprising a partially hydrolyzed organo-functional polysilane and a polymerizable aromatic oxetane, and
b) a combination provided by curing on the polymeric surface a composition comprising a partially hydrolyzed organo-functional polysilane and a polymerizable oxetane, and the substrate comprising a high index material.

Particularly preferred high index materials of this type comprise a polyisocyanate compound and a polythiol compound, to provide are described in U.S. Pat. No. 5,652,321, the disclosure of which is incorporated herein by reference. Such materials are described as having an extremely high refractive index and excellent heat resistance, as exemplified in commercial products such as the MR8 and MR10 lines of lenses available from Mitsui Toatsu Chemicals, Inc.

In one preferred embodiment, the present invention provides a substantially colloidal silica-free and substantially solvent-free curable coating composition for forming a coating upon a substrate. The coating composition, in turn, preferably comprises a binder component and a curing agent component, the binder component comprising a partially hydrolyzed organo-functional silane and an aromatic oxetane, e.g., selected from the group consisting of bi- or higher-functional aromatic oxetanes.

In another preferred embodiment, the coating composition can include an aliphatic or aromatic oxetane, and is particularly well suited for use in combination with relatively new class of high index polymeric substrates.

The composition can further comprise additional ingredients, including a viscosity modifying amount of one or more substantially non-hydrolyzed silanes, as well as one or more polymerizable monomers (e.g., ethylenically unsaturated monomers), in combination with one or more cationic initiators and one or more free radical initiators.

The composition can be used, in turn, to provide a coating having an optimal combination of such properties as transparency, adhesion, abrasion-resistance, dye-acceptance, and stability. Not intending to be bound by theory, it would appear that the preferred oxetanes of this invention themselves provide ether groups that contribute to the tintability of the overall composition. In turn, a UV-coated composition of the present invention can be used as a base to provide abrasion resistance (e.g., Bayer abrasion) that approximates that of a comparable thermally cured base coating, when used as the base coat for an antireflective coating (stack) positioned thereon. The present composition, however, provides various advantages over such thermal cure coatings, including shorter processing times, while providing tintability that is as good or better than conventional compositions.

The composition can be used to provide an improved combination of properties, particularly for use in coating lenses and other transparent polymeric materials. Such lens materials include those having an array of properties (e.g., refractive index), and preferably includes both polycarbonate and high index lenses. The coating composition is itself substantially solvent free, and in turn, provides minimal if any volatiles in the course of its application, curing, or use.

In turn, the composition is particularly well suited for use as the base coat, before the application of one or more additional layers. Such additional layers often include, for instance, a quartz or oxide (e.g., silicon dioxide) layer, followed by a plurality of coated layers. The resulting “stack” of coated layers can be applied in order to provide an improved array of properties to the overall coated material, including in particular abrasion resistance, as compared to conventional compositions.

Compositions of this invention are particularly well suited for polymeric substrates, and particularly high refractive index substrates intended for optical applications, including thermosetting and thermoplastic polycarbonates, as well as polyurethanes. Such substrates can be used for a variety of applications, including for automotive instrumentation, aviation gauges and instruments, display and/or shielding windows, eyewear lenses, handheld meters and devices, molded display windows and panels, outdoor equipment gauges and displays, test & laboratory instrument displays, screen printing POP signage, thermoformed displays, medical displays and panels, and video and LED filters.

### DESCRIPTION OF THE PREFERRED EMBODIMENT

Applicant has discovered the manner in which particular polymerizable monomers from the group described as oxetanes can be used in combination with organofunctional silanes in order to provide improved compositions, and corresponding base coats having excellent adhesion to polycarbonate and other substrates. More preferably, and desirably, the compositions of this invention have comparable or even improved tintability, as compared to conventional compositions. The compositions can be used as the base coat for subsequent anti-reflective coating in a manner that provides the final surface with improved abrasion resistance (e.g., as determined by Bayer abrasion), particularly as compared to a conventional base coat (e.g., one that instead incorporates a polymerizable ether (e.g., glycidyl ether) in combination with the same or similar silane).

The formation of an abrasion resistant coating, for use on eyeglass lenses, will typically begin with the application of a composition of this invention, e.g., by spin coating and curing the composition with infrared energy. Thereafter, the coated base composition can be subjected to one or more intermediate treatments, for instance, it can be tinted using conventional means, e.g., by dipping the coated lens into a tint bath.

Once the base composition has been applied, cured, and tinted, the lens material can be subjected to a conventional coating machine, for the application of an antireflection coating, in the form of a ‘stack’ or plurality of layers. Once coated with the composition of this invention, in the form of an initial base coat, the coated lens is typically degassed (e.g., under suitable conditions of time, vacuum, and temperature), followed by the application of an intermediate layer (e.g., quartz or silicon dioxide), which itself can be compacted by e-beam or other means, and finally by the application of one or more AR coatings applied by means of vapor deposition.

An ‘oxetane’ is generally defined as a compound that includes at least one four membered cyclic ether. According to literature from Toagosei Co., Ltd., such compounds are said to provide the highest basicity among cyclic ethers (e.g., on the order of 2.1 pKa), and higher ring strain (e.g., on the order of 107 kJ/mol), thereby providing such properties as high conversion and high polymerizability. Given the present description, those skilled in the art will appreciate the manner in which the oxetane can be selected and used to provide desired performance, for instance, based upon the overall formulation, the substrate being coated, additional AR or other coatings to be used, and conditions of use.

A composition of this invention further comprises one or more polymerizable oxetanes, in some embodiments preferably a bi- or higher-functional oxetane, and more preferably 1,4-bis[(3-ethyl-3-oxetaneylmethoxy)methyl]benzene (commonly known as xylilene oxetane)*, and available commercially under the product name Aron Oxetane OXT-121 (XDO) from Toagosei Co., Ltd. The polymerizable oxetane monomer is present in the coating compositions of the invention at a weight concentration (solids basis) between about 5 and about 50 weight percent, more preferably between about 10 and 40 weight percent, and most preferably between about 30 and about 40 weight percent. Increasing amounts within these ranges tend to correspond with improved properties, such as improved tintability.

In other embodiments, the oxetane can be an aliphatic oxetane, e.g., as available under the tradename OXT-221 from Toagosei Co., Ltd., and defined in their product literature as 3-ethyl-3-{[3-ethyloxetane-3-yl)methoxy]methyl}oxetane.

In a preferred embodiment, a composition of the present invention comprises a partially hydrolyzed organo-functional alkoxysilane in combination with a polymerizable oxetane, and optionally other ingredients. The organo-functional alkoxysilane can be of any suitable type, and is preferably selected from the group consisting of epoxy-, vinyl- and acryloxy-functional alkoxysilanes. The organo-functional alkoxysilane, when present, can be used in any suitable amount, e.g., between about 10 and about 50 weight percent, and more preferably between about 20 and about 40 weight percent.

Suitable acryloxy-functional organosilanes include, are selected from the group consisting of: 3((meth)acryloxypropyl)trimethoxy silane, 3((meth)acryloxyproply)methyl dimethoxy silane, and 3((meth)acryloxypropyl)dimethyl methoxy silane, including combinations thereof.

Suitable vinyl-functional organosilanes include, but are selected from the group consisting of: vinyldimethyl ethoxysilane, vinylmethyl dimethoxysilane, vinylphenyl diethoxysilane, vinyltrimethoxysilane, and vinyltriethoxysilane, including combinations thereof.

Suitable epoxy functional alkoxy silane precursors, for use in preparing the at least partially hydrolyzed polymerizable ingredient, are selected from the group consisting of epoxyalkylalkoxysilanes of the following structure: EQU Q-R₁—Si(R₂)ₘ—(OR₃)₃₋ₘ,

The epoxy functional alkoxy silane precursor of the at least partially hydrolyzed polymerizable ingredient is preferably an epoxyalkylalkoxysilane of the following structure: Q-R₁—Si(R₂)ₘ—(OR₃)₃₋ₘ

wherein R₁ is a C₁-C₁₄ alkylene group, R₂ and R₃ independently are C₁-C₄ alkyl groups and Q is a glycidoxy or epoxycyclohexyl group, and m is 0 or 1. The alkoxy groups are at least partially hydrolyzed to form silanol groups with the release of the R₃OH alcohol, and some condensation of the silanol groups occurs. Epoxy reactivity is preserved, however. Many epoxy-functional alkoxysilanes are suitable as hydrolysis precursors, including glycidoxymethyl-trimethoxysilane, glycidoxymethyltriethoxysilane, glycidoxymethyl-tripropoxysilane, glycidoxymethyl-tributoxysilane, b-glycidoxyethyltrimethoxysilane, b-glycidoxyethyltriethoxysilane, b-glycidoxyethyl-tripropoxysilane, b-glycidoxyethyl-tributoxysilane, b-glycidoxyethyltrimethoxysilane, a-glycidoxyethyl-triethoxysilane, a-glycidoxyethyl-tripropoxysilane, a-glycidoxyethyltributoxysilane, g-glycidoxypropyl-trimethoxysilane, g-glycidoxypropyl-triethoxysilane, g-glycidoxypropyl-tripropoxysilane, g-glycidoxypropyltributoxysilane, b-glycidoxypropyl-trimethoxysilane, b-glycidoxypropyl-triethoxysilane, b-glycidoxypropyl-tripropoxysilane, b-glycidoxypropyltributoxysilane, a-glycidoxypropyl-trimethoxysilane, a-glycidoxypropyl-triethoxysilane, a-glycidoxypropyl-tripropoxysilane, a-glycidoxypropyltributoxysilane, g-glycidoxybutyl-trimethoxysilane, d-glycidoxybutyl-triethoxysilane, d-glycidoxybutyl-tripropoxysilane, d-glycidoxybutyl-tributoxysilane, d-glycidoxybutyl-trimethoxysilane, g-glycidoxybutyl-triethoxysilane, g-glycidoxybutyl-tripropoxysilane, g-propoxybutyl-tributoxysilane, d-glycidoxybutyl-trimethoxysilane, d-glycidoxybutyl-triethoxysilane, d-glycidoxybutyl-tripropoxysilane, a-glycidoxybutyl-trimethoxysilane, a-glycidoxybutyl-triethoxysilane, a-glycidoxybutyl-tripropoxysilane, a-glycidoxybutyl-tributoxysilane, (3,4-epoxycyclohexyl)-methyl-trimethoxysilane, (3,4-epoxycyclohexyl)methyl-triethoxysilane, (3,4-epoxycyclohexyl)methyl-tripropoxysilane, (3,4-epoxycyclohexyl)-methyl-tributoxysilane, (3,4-epoxycyclohexyl)ethyl-triethoxysilane, (3,4-epoxycyclohexyl)ethyl-triethoxysilane, (3,4-epoxycyclohexyl)ethyl-tripropoxysilane, (3,4-epoxycyclohexyl)-ethyl-tributoxysilane, (3,4-epoxycyclohexyl)propyl-trimethoxysilane, (3,4-epoxycyclohexyl)propyl-triethoxysilane, (3,4-epoxycyclohexyl)propyl-tripropoxysilane, (3,4-epoxycyclohexyl)propyl-tributoxysilane, (3,4-epoxycyclohexyl)butyl-trimethoxysilane, (3,4-epoxycyclohexy)butyl-triethoxysilane, (3,4-epoxycyclohexyl)-butyl-tripropoxysilane, and (3,4-epoxycyclohexyl)butyl-tributoxysilane.

A particularly preferred organo-functional alkoxysilane is γ-glicidoxypropyl trimethoxy silane due to its wide commercial availability.

Hydrolysis of the alkoxy-functional alkoxysilane precursor may occur in an acidic environment, and reference is made to U.S. Pat. No. 4,378,250, the teachings of which are incorporated herein by reference. Hydrolysis of the alkoxy groups liberates the associated alcohol to form silanol groups; these, in turn, are relatively unstable and tend to condense spontaneously. Preferably, the alkoxysilane is reacted with a stoichiometricly sufficient quantity of water to hydrolyze at least 50% of the alkoxy groups and most preferably from about 60% to about 70% of the alkoxy groups. For the hydrolysis of an epoxy-functional trialkoxy silane, good results have been obtained by reacting the silane with a stoichiometricly sufficient quantity of water to hydrolyze two-thirds of the alkoxy groups.

The at least partially hydrolyzed alkoxy-functional silane is present in the coating compositions of the invention at a weight concentration (solids basis) of 10% to 75%, and preferably 20% to 50%. Those skilled in the art, given the present description, will appreciate the manner in which both the actual and relative amounts of the partially hydrolyzed organofunctional polysiloxane, and any non-hydrolyzed monomeric silane that may be included, can be considered and controlled to provide varying desired properties, particularly including desired viscosity.

The composition of this invention further comprises a monomeric organofunctional silane, and more preferably a monomeric (silanol free) alkoxy functional silane, which can also be referred to as an unhydrolyzed alkoxy functional alkoxy silane. In turn, certain preferred compositions can include both hydrolyzed and unhydrolyzed alkoxy functional alkoxy silanes, with the latter being present in an amount sufficient to reduce the viscosity of the composition itself. It is noted that, while the “hydrolysis product” of such a silane can certainly include compounds that are themselves partially hydrolyzed (depending on the mole ratio of water to alkoxy groups as described herein), whereas an unhydrolyzed silane of the sort claimed is clearly one that is prepared and used in the substantial absence of water. As described herein, water is removed from the hydrolysis product component, prior to the addition of an unhydrolyzed component, in order to permit the latter to retain its unhydrolyzed nature. Hence, when and to the extent “partially hydrolyzed” silanes might be discussed in the art, these compounds tend to be different than, and not at all suggestive of the use of both hydrolyzed and unhydrolyzed silane components as presently described.

In turn, the composition desirably includes an effective amount up of a suitable non-hydrolyzed alkoxy functional silane, including those selected from the silanes listed above. When used in combination with an organofunctional polysiloxane, the non-hydrolyzed epoxy functional alkoxy silane desirably is present in an amount not less than about 10%, preferably at least about 20%, and most preferably from about 40% to about 50% by weight, solids basis. Preferably, the epoxy functional alkoxy silane that is included as the non-hydrolyzed component also is of the same or similar type as that employed to make the hydrolyzed component. It should be understood that the hydrolyzed and non-hydrolyzed components may be different and each may utilize one or a blend of different epoxy functional alkoxy silanes, as desired.

The monomeric silane is optional, and therefore used in an amount of between about 0% and about 30%, and more preferably between about 10% and about 25% by weight of the composition.

A composition of the present invention can further comprise one or more additional reactive ingredients, selected from the group consisting of one or more non-hydrolyzed silanes, one or more polyermizable ethers, and one or more ethylenically unsaturated monomer components, desirably an acrylic monomer component that preferably includes a monomer having an acrylic functionality of not more than two.

A wide variety of ethylenically unsaturated monomers (including oligomers) can be employed in the coating composition of the invention, and acrylic monomers and oligomers, particularly those having acrylic functionalities of not greater than two, are preferred. Useful acrylic compounds for improving adhesion to polycarbonate substrates include both mono and di-functional monomers, but other or additional polyfunctional acrylic monomers may also be included.

Examples of monofunctional acrylic monomers include acrylic and methacrylic esters such as ethyl acrylate, butyl acrylate, 2-hydroxypropyl acrylate, cyclohexyl acrylate, 2-ethylhexyl acrylate, methyl methacrylate, ethyl methacrylate, and the like. Examples of polyfunctional acrylic monomers, including both difunctional and tri and tetrafunctional monomers, include neopentylglycol diacrylate, pentaerythritol triacrylate, 1,6-hexanediol diacrylate, trimethylolpropane triacrylate, tetraethylene glycol diacrylate, 1,3-butylene glycol diacrylate, trimethylolpropane trimethacrylate, 1,3-butylene glycol dimethacrylate, ethylene glycol dimethacrylate, pentaerythritol tetraacrylate, tetraethylene glycol dimethacrylate, 1,6-hexanediol dimethacrylate, ethylene glycol diacrylate, diethylene glycol diacrylate, glycerol diacrylate, glycerol triacrylate, 1,3-propanediol diacrylate, 1,3-propanediol dimethacrylate, 1,2,4-butanetriol trimethacrylate, 1,4-cyclohexanediol diacrylate, 1,4-cyclohexanediol dimethacrylate, pentaerythritol diacrylate, 1,5-pentanediol dimethacrylate, and the like. The acrylic-functional monomers and oligomers desirably are employed at a weight concentration of at least about 10% by weight, preferably from about 10% to about 50%, and most preferably from about 10% to about 25%, all on a solids basis.

The composition preferably also contains one or more cationic photoinitiators, sufficient to polymerize the epoxy-functional components, and one or more free radical initiators sufficient to initiate polymerization of the ethylenically unsaturated coating components (e.g., acrylic-functional components).

Useful cationic initiators for the purposes of this invention include the aromatic onium salts, including salts of Group Va elements, such as phosphonium salts, e.g., triphenyl phenacylphosphonium hexafluorophosphate, salts of Group VIa elements, such as sulfonium salts, e.g., triphenylsulfonium tetrafluoroborate, triphenylsulfonium hexafluorophosphate and triphenylsulfonium hexafluoroantimonate, and salts of Group VIIa elements, such as iodonium salts, e.g., diphenyliodonium chloride. The aromatic onium salts and their use as cationic initiators in the polymerization of epoxy compounds are described in detail in U.S. Pat. No. 4,058,401, “Photocurable Compositions Containing Group VIA Aromatic Onium Salts,” by J. V. Crivello issued Nov. 15, 1977; U.S. Pat. No. 4,069,055, “Photocurable Epoxy Compositions Containing Group VA Onium Salts,” by J. V. Crivello issued Jan. 17, 1978; U.S. Pat. No. 4,101,513, “Catalyst For Condensation Of Hydrolyzable Silanes And Storage Stable Compositions Thereof,” by F. J. Fox et al. issued Jul. 18, 1978; and U.S. Pat. No. 4,161,478, “Photoinitiators,” by J. V. Crivello issued Jul. 17, 1979, the disclosures of which are incorporated herein by reference. Other cationic initiators can also be used in addition to those referred to above; for example, the phenyldiazonium hexafluorophosphates containing alkoxy or benzyloxy radicals as substituents on the phenyl radical as described in U.S. Pat. No. 4,000,115, “Photopolymerization Of Epoxides,” by Sanford S. Jacobs issued Dec. 28, 1976, the disclosure of which is incorporated herein by reference. Preferred cationic initiators for use in the compositions of this invention are the salts of Group VIa elements and especially the sulfonium salts. Particular cationic catalysts include diphenyl iodonium salts of tetrafluoro borate, hexafluoro phosphate, hexafluoro arsenate, and hexafluoro antimonate; and triphenyl sulfonium salts of tetrafluoroborate, hexafluoro phosphate, hexafluoro arsenate, and hexafluoro antimonate.

Although photoactivated free-radical initiator are preferred, thermally activated free radical and cationic initiators may also be used. Useful photoinitiators for this purpose are the haloalkylated aromatic ketones, chloromethylbenzophenones, certain benzoin ethers, certain acetophenone derivatives such as diethoxyacetophenone and 2-hydroxy-2-methyl-1-phenylpropan-1-one. A preferred class of free-radical photoinitiators is the benzil ketals, which produce rapid cures. A preferred photoinitiator is α,α-dimethoxy-α-phenyl acetophenone (Iragacure™ 651, Ciba-Geigy, disclosed in U.S. Pat. Nos. 3,715,293 and 3,801,329). The most preferred photoinitiator, in accordance with this invention, is 2-hydroxy-2-methyl-1-phenylpropane-1-one (Darocure™ 1173, Ciba-Geigy Corporation). Specific examples of photoinitiators include ethyl benzoin ether, isopropyl benzoin ether, dimethoxyphenyl acetophenone, diethoxy acetophenone, and benzophenone.

A preferred class of free-radical photoinitiators is the benzil ketals, which produce rapid cures. Suitable photoinitiators include .alpha.,.alpha.-dimethoxy-.alpha.-phenyl acetophenone (Iragacure™ 651), and 2-hydroxy-2-methyl-1-phenylpropane-1-one (Darocure™ 1173, Ciba-Geigy Corporation). A preferred photoiniator is 1-hydroxycyclohexyl phenyl ketone (available as Irgacure 184). Specific examples of photoinitiators include ethyl benzoin ether, isopropyl benzoin ether, dimethoxyphenyl acetophenone, diethoxy acetophenone, and benzophenone. Other examples of suitable initiators are diethoxy acetophenone (“DEAP”, First Chemical Corporation) and 1-benzoyl-1-hydroxycyclohexane (“Irgacure 184”, Ciba Geigy).

Compositions of the present invention can be used to coat a variety of materials, generally polymeric materials, and most preferably those used for the manufacture of optical lenses. Those skilled in the corresponding art will appreciate the manner in which the lens material chosen for a particular use or prescription can be differentiated by various factors, including its weight, thickness, transmission of radiant energy and optical performance.

The following table shows the index of refraction of some of the different lens materials.

| Lens Material | Index Refraction |
|---|---|
| CR-39 Plastic | 1.498 |
| Crown Glass | 1.523 |
| Spectralite | 1.537 |
| Mid-index Plastic | 1.556 |
| Polycarbonate | 1.586 |
| 1.6 Index Plastic | 1.594 |
| 1.6 Index Glass | 1.601 |
| 1.66 Index Plastic | 1.660 |
| 1.7 Index Glass | 1.701 |
| 1.8 Index Glass | 1.805 |

In one preferred embodiment, a composition of the present invention will typically provide a unique fingerprint upon analysis infrared spectrophotometry, including a distinguishing absorption peak at 970 nm corresponding to the oxetane group, in an uncured composition of this invention, which disappears in the cured composition. This can be compared, for instance, to the presence of an absorption peak in the range of 760-780 nm corresponding to a comparable product that includes instead the use of epoxy groups, e.g., as provided by the silane and other compounds.

### EXAMPLES

The invention may be better understood by reference to the following non-limiting examples. Unless otherwise indicated, the concentration of ingredients in a composition is described as a percentage (solids basis) based on the weight of the overall composition. Cured coatings were subjected to several tests, outlined as follows:

### Scratch Resistance

Bayer abrasion testing is performed by suitable modification of the oscillating sand method (ASTM-F735-94 Standard Test Method for Abrasion Resistance of Transparent Plastics and coatings), modified slightly to allow for use in the optical field. The test consists of a small pan that is shaken back and forth a distance of 4 inches, at 150 cycles for 4 minutes, using abrasion media the material known as Kryptonite B, available from Colts Laboratories. Holes have been placed through the center section of the pan to allow the lenses to protrude up through the center of each hole, allowing the abrasion to take place without the loss of media.

### Adhesion

Adhesion may be measured using the procedures of ASTM 3359. This test, in brief, provides for scoring of the cured coating with a sharp instrument in a cross-hatched fashion to leave diamond-shaped patches, followed by an attempt to lift the diamond-shaped patches from the substrate through the use of a pressure sensitive adhesive tape that is applied to the cross hatched surface and then pulled away. The degree to which the cross-hatched portions of the coating remain adhered to the substrate provides a measure of adhesion to that substrate, and is reported as the percentage of diamond-shapes that remain adhered to the substrate.

### Tintability

A coated and cured sample is immersed in BPI Black Dye (Brain Power Inc.) at 98-102° C. for 15 minutes and then rinsed with water and dried. Transmissivity is measured spectrophotometrically, and tintability is reported as percentage transmissivity.

### EXAMPLES

INGREDIENTS KEY (product name, chemical description, source):
A187 Glycidoxy propyl trimethoxy silane (GE Silicones)
A186 Epoxy Cyclohexyl Trimethoxy Silane (GE Silicones)
A 1630 Methyl trimethoxy silane (Crompton Corp)
SR 9209 alkoxylated aliphatic diacrylate (Sartomer, Inc.)
SR 444 pentaerythritol triacrylate (Sartomer, Inc.)
SR-351 trimethylolpropane triacrylate (TMPTA, Sartomer, Inc.)
SR-238 1,6 hexanediol diacrylate (HDODA, Sartomer, Inc.)
DEAP 2,2-diethoxy acetophenone, free radical initiator (First Chemical Corporation)
CPI 6976 Cationic initiator (Aceto Corp.)
CPI 6972 Cationic initiator (Aceto Corp.)
Irgacure 184 Free radical photoiniator (Ciba Geigy)
Irgacure 250 Cationic photoiniator (Ciba Geigy)
Uvacure 1502 Cycloaliphatic epoxy resin (UCB Chemicals Corp)
OXT-221 bis[1-ethyl(3-oxetanyl)]methyl ether (Toagosei, Ltd)
BYK 307 Silicone type flow control agent (BYK-Chemie)
HELOXY™ 107 diglycidyl ether of cyclohexane dimethanol (Momentive, Inc.)
HELOXY™ 48 low viscosity aliphatic triglycidyl ether (Momentive, Inc.)

### Example 1

An experiment was performed in order to compare a silane composition containing a preferred monomer of the present invention, 1,4-Bis[(3-ethyl-3-oxetanylmethoxy)methyl]benzene, which is an aromatic, difunctional oxetane available commercially as “OXT-121”), with a silane that instead contained an aliphatic, difunctional oxetane, (bis[1-Ethyl(3-oxetanyl)]methylether (available commercially as “OXT-221”).

A stripped, hydrolyzed epoxy silane resin (resin A) was prepared as the reaction product of nonhydrolyzed silane (A187), together with H2O, and (10%) HCl, in the manner described in U.S. Pat. No. 6,100,313 and U.S. Ser. No. 12/987,650, the disclosures of which are incorporated herein by reference. Various compositions were prepared as described herein, based upon the master batch, and were coated on a variety of conventional lens materials that included a polycarbonate, a 1.6 index material, and a 1.67 index material. All amounts are in weight percent, unless otherwise indicated. Initial results are provided below.

| Compositions | (OXT-121 - aromatic) | (OXT 221 - aliphatic) |
|---|---|---|
| Hydrolysed epoxy silane | 31.0 | 31.0 |
| Resin A | | |
| Glycidoxypropyl | 19.0 | 19.0 |
| trimethoxy silane (A187) | | |
| Hexanediol diacrylate | 14.75 | 14.75 |
| (HDODA, SR238) | | |
| Oxetane component | 30 | 30 |
| Irgacure 184 | 0.75 | 0.75 |
| Free radical initiator | | |
| Cationic initiator | 4.25 | 4.25 |
| BYK307 | 0.25 | 0.25 |
| Silicone flow control | | |
| agent | | |
| Total | 100 | 100 |

Results were as follows:

| | | |
|---|---|---|
| Tint | 30 | 32 |
| Adhesion after tint | | |
| Polycarbonate | pass | pass |
| 1.6 index material (MR8) | pass | fail |
| 1.67 index material (MR10) | pass | fail |

It can be seen that, under the conditions of the current experiment, the composition based upon the use of Oxetane 221 failed adhesion to the higher index lens material, after tint, and was therefore not deemed suitable to be further coated with an AR (antireflective) coating). In turn, the composition that included the use of Oxetane 121 is preferred, in that it is suitable for use on a variety of conventional polymeric eyeglass materials.

### Example 2

An experiment was performed to evaluate the performance of silane compositions having different ether components.

Sample A contained a conventional difunctional aliphatic glycidyl ether, while Sample B contained a preferred oxetane of the present invention; and sample C contained yet another difunctional aromatic glycidyl ether (Epon 828), which is not an oxetane, though is otherwise structurally similar to Oxetane 121.

EPON™ Resin 828 is described in the literature as an undiluted clear difunctional bisphenol A/epichlorohydrin derived liquid epoxy resin, and has become a standard epoxy resin used in formulation, fabrication and fusion technology.

The following compositions were prepared:

| | A | B | C |
|---|---|---|---|
| Hydrolyzed epoxy silane | 55.0 | 49.9 | 49.9 |
| Resin A | | | |
| Hexanediol diacrylate | 14.3 | 14.9 | 14.9 |
| (HDODA, SR238) | | | |
| Cyclohexane dimethanol | | | |
| Diglycidyl ether (Heloxy 107) | 23.75 | — | — |
| OXT 121 - | — | 29.93 | — |
| Epon 828 | — | — | 29.93 |
| Irgacure 184 | 0.71 | 0.75 | 0.75 |
| Free radical initiator | | | |
| Cationic initiator | 4.25 | 4.25 | 4.25 |
| BYK307 | 0.25 | 0.25 | 0.25 |
| Silicone flow control agent | | | |

The three compositions were coated on polycarbonate lenses, cured and evaluated for both adhesion to a polycarbonate substrate (etched CR 39 lenses), followed by abrasion resistance once coated by a conventional antireflective coating (AVANCE™ Essilor).

Results are as follows:

| | | | |
|---|---|---|---|
| Bayer abrasion | 5.19 | 7.4 | (failed) |
| Transmission | 24.6 | 32.3 | 20.4 |

It can be seen that the composition that included Epon 828 failed adhesion and was discarded. In turn, while both compositions A and B are tintable, the composition (B) of this invention provided significantly improved abrasion properties under the conditions tested.

### Example 3

An experiment was performed to compare a silane coating composition having a difunctional aromatic oxetane of this invention, with a corresponding silane composition that contained instead a trifunctional ether (in particular, trimethylolpropane triglycidyl ether, of the type described in Applicant's prior U.S. Pat. No. 6,100,313).

| Ingredient | ′313 patent | aromatic oxetane |
|---|---|---|
| Hydrolyzed epoxy silane | 33.85 | 50 |
| Resin A | | |
| Hexanediol acrylate | 27.61 | 10 |
| HDODA (SR238) | | |
| Polymerizable ether | | |
| trimethylolypropane (Heloxy 5048) | 32.78 | — |
| Oxetane 121 (aromatic) | — | 34.75 |
| Irgacure 184 | 2.2 | 0.5 |
| (free radical initator) | | |
| BYK 307 | 0.25 | 0.25 |
| (flow control agent) | | |
| Total | 100 | 100 |

Results were as follows:

| | | |
|---|---|---|
| Tint | 24 | 27 |
| Bayer Abrasion w/AR | 4.5 | 7.4 |

Heloxy Modifier 107 (Momentive, Inc.) is the diglycidyl ether of cyclohexane dimethanol. While it is primarily used as a reactive diluent or viscosity reducing modifier for epoxy resin formulations, it also can effectively serve as a reactive intermediate for further synthesis of various cycloaliphatic based resins.

By comparison, Heloxy Modifier 48 is a low viscosity aliphatic triglycidyl ether useful in the viscosity, reactivity, and performance modification of epoxy resin systems.

It can be seen that, under the conditions tested, the composition containing the oxetane provided superior results in terms of abrasion resistance, as compared to the conventional composition.

With regard to the slight difference between the two compositions, in terms of tint, it is clear that conventional coating laboratories will be able to use and accommodate their processes accordingly, in order to achieve whatever levels of tint they may need, e.g., by extending the time in the tint bath.

While a preferred embodiment of the present invention has been described, it should be understood that various changes, adaptations and modifications may be made therein without departing from the spirit of the invention and the scope of the appended claims.

### Example 4

An experiment was performed to determine the effect of various compositions in coating high index lenses, and in particular, those lenses prepared from conventional materials prepared from polymers sold under the brandnames MR6 and MR7 (Mitsui Chemical), as compared to those lenses prepared from newer materials and prepared from polymers sold under the brandnames MR8 and MR10. The following compositions were prepared and used as described herein.

| Compositions | Amount |
|---|---|
| Hydrolysed epoxy silane | 31 |
| Resin A | |
| Glycidoxypropyl trimethoxy | 19 |
| silane (A187) | |
| Hexanediol diacrylate | 15 |
| (HDODA, SR238) | |
| Ether component* | 30 |
| Irgacure 184 | 0.75 |
| Free radical initiator | |
| Cyracure 6976 | 4.25 |
| Cationic initiator | |
| BYK307 | 0.2 |
| Silicone flow control agent | |
| Total | 100 |

*Ether component
A - Cyclohexanediemethanol diglycidyl ether
B - Trimethylolpropane triglycidylether
C - OXT 221 (aliphatic)
D - OXT 121 (aromatic)

All samples were coated on 1.6 RI LENSES made from monomer blend MR8 at 4-5 microns thickness and UV cured using high pressure mercury lamp. The same results were obtained when coated on 1.67 RI LENSES made from MR10 monomer blend. The samples were evaluated for adhesion as per ASTM D 3359 as above.

Results—samples having ether components A and B failed the adhesion test when used on MR8 and MR10 lenses, while those having ether components C and D passed the test, for all lenses tested. When coated on lenses with RI 1.6 and 1.67 but made from monomer blends MR6 and MR7 respectively all samples passed adhesion.

| Ether | MR6 (1.60) | MR7 (1.66) | MR8 (1.60) | MR10 (1.67) |
|---|---|---|---|---|
| A | Pass | Pass | Fail | Fail |
| B | Pass | Pass | Fail | Fail |
| C | Pass | Pass | Pass | Pass |
| D | Pass | Pass | Pass | Pass |

1. A combination comprising a coated and cured composition upon the surface of a polymeric material, the combination being selected from the group consisting of:
a) a combination provided by curing on the polymeric surface a composition comprising a partially hydrolyzed organo-functional polysilane and a polymerizable aromatic oxetane, and
b) a combination provided by curing on the polymeric surface of a high index material a composition comprising a partially hydrolyzed organo-functional polysilane and a polymerizable oxetane.

2. A combination according to claim 1, wherein the oxetane comprises a bi- or higher-functional oxetane.

3. A combination according to claim 2, wherein the aromatic oxetane comprises 1,4-bis[(3-ethyl-3-oxetaneylmethoxy)methyl]benzene.

4. A combination according to claim 3, further comprising one or more ingredients selected from the group consisting of an ethylenically unsaturated monomer, a cationic initiator, and a photoinitiator.

5. A combination according to claim 1, wherein the cured composition provides an improved combination of properties selected from the group consisting of transparency, adhesion, abrasion-resistance, dye-acceptance, and stability as compared to a cured composition that includes a polymerizable glycidyl ether instead of the oxetane component.

6. A combination according to claim 1, wherein the uncured composition comprises a non-hydrolyzed silane in an amount sufficient to modify the viscosity of the coating composition.

7. A combination according to claim 1, wherein the uncured composition comprises:
a) a partially hydrolyzed alkoxy-functional silane, selected from the group consisting of epoxy-, vinyl- and acryloxy-functional alkoxysilanes,
b) a substantially non-hydrolyzed alkoxy-functional silane,
c) an ethylenically unsaturated monomer,
d) a cationic initiator, and
e) a free radical initiator.

8. A combination according to claim 1, wherein the polymeric material comprises a polycarbonate material.

9. A combination according to claim 1, wherein the combination further comprises a plurality of layers coated upon the cured composition.

10. A method of coating a composition upon the surface of a polymeric material, the method being selected from the group consisting of:
a) coating and curing on the polymeric surface a composition comprising a partially hydrolyzed organo-functional polysilane and a polymerizable aromatic oxetane, and
b) coating and curing on the polymeric surface of a high index material a composition comprising a partially hydrolyzed organo-functional polysilane and a polymerizable oxetane.
